(19) United States
(12) Patent Application Publication
(10) Pub. No.: US 2026/0004119 A1
(43) Pub. Date: Jan. 1, 2026

(54) METHOD AND SYSTEM FOR QUANTIFYING UNCERTAINTIES IN OUTPUT DATA FROM A MACHINE LEARNING SYSTEM AND METHOD FOR TRAINING A MACHINE LEARNING SYSTEM

(71) Applicant: Continental Autonomous Mobility Germany GmbH, Ingolstadt (DE)

(72) Inventors: Armin Staudenmaier, Hörbranz (AT); Karl Matthias Nacken, Lindau (DE)

(73) Assignee: Continental Autonomous Mobility Germany GmbH, Ingolstadt (DE)

(21) Appl. No.: 18/714,492

(22) PCT Filed: Nov. 24, 2022
(86) PCT No.: PCT/DE2022/200275

§ 371 Date: May 29, 2024

(30) Foreign Application Priority Data
Nov. 29, 2021 (DE) 10 2021 213 392.4

(51) Int. Cl. G06N 3/08; G06N 3/0464

(52) U.S. Cl. CPC G06N 3/08; G06N 3/0464

(57) ABSTRACT

A method for training a machine learning (ML) system to quantify uncertainties in output data is disclosed. Training data, including training input data and training target values, are used to adjust parameters of the ML system. The ML system, when the training input data are input, generates output data similar to the training target values; and generates reconstruction data representing a measure of familiarity of training data. The method relates to quantifying uncertainties (U) in output data (Y′) from the machine learning system (1) trained in accordance with the above method. The ML system generates output data from input data and generates the reconstruction data. A metric, the reconstruction data and data corresponding to the reconstruction data are used to generate a deviation value, which is a measure of familiarity of training data for the input data, quantifies the uncertainty and is assigned to the output data.

### CROSS-REFERENCE TO RELATED APPLICATIONS

The present application is a National Stage Application under 35 U.S.C. § 371 of International Patent Application No. PCT/DE2022/200275 filed on Nov. 24, 2022, and claims priority from German Patent Application No. 10 2021 213 392.4 filed on Nov. 29, 2021, in the German Patent and Trademark Office, the disclosures of which are herein incorporated by reference in their entireties.

### FIELD OF THE INVENTION

The present invention relates to machine learning. In particular, the present invention relates to a method for training a machine learning system to quantify uncertainties, a method for quantifying uncertainties in output data from a machine learning system, a system for quantifying uncertainties in output data from a machine learning system as well as a vehicle comprising a system for quantifying uncertainties in output data.

### BACKGROUND

Machine learning has become a valuable tool in many areas. It is also increasingly important to reliably estimate uncertainties in the outputs from machine learning systems.

Thus, a reliable estimation of the uncertainties in classification outputs, for example, is a safety-relevant aspect during autonomous driving. In this case, accidents can be avoided by recognizing situations in which the system is unsafe, and by handing over control to the driver or by reducing the speed.

In particular in the case of convolutional neural networks, the process of estimating the uncertainties constitutes a challenging problem since, due to the non-linearities of the convolutional neural network, the classification error does not correlate with the actual uncertainty here. This effect is intensified the more complex the convolutional neural networks are, for example as a result of adding further layers with non-linear activation functions or as a result of normalization methods.

Known methods for calculating uncertainties are the Monte Carlo dropout method and the ensemble method. Both methods are based on the principle of statistical modeling of the scattering of the classification results by generating multiple results for one input signal. The more these results differ, the higher the uncertainty. To this end, in the case of the Monte Carlo dropout method, network weights are turned off randomly, whereas in the case of the ensemble method, one output is generated per ensemble participant. A significant number of results is required for representative statistics. As a result of the high computational complexity necessary for this, these methods are, in general, not suitable for deployment in real-time capable systems. Furthermore, the ensemble method requires a large amount of storage space.

### SUMMARY

It is therefore an aspect of the present disclosure to provide a method which quantifies uncertainties in output data from a machine learning system with moderate computational expense. This aspect is addressed by the subject- matter of the independent patent claims. Further developments of the present disclosure are set out in the subclaims and the following description.

One aspect of the present disclosure relates to a method for training a machine learning system to quantify uncertainties in output data. Training data, which includes training input data and training target values, are provided. The training target values are assigned to the respective training input data. The training target values have, for example, been created manually for the individual training input data and represent, for example, a classification of the training input data.

The training data are used to train the machine learning system, i.e., to adjust parameters of the machine learning system such that the machine learning system, when the training input data are input, generates output data similar to the training target values. For example, in the case of neural networks, the parameters include the weightings between individual input values and neurons. The machine learning system is trained by means of a monitored learning method, wherein a plurality of learning methods is known. For example, the backpropagation method can be used to train a neural network. In the course of the training, the parameters of the machine learning system are adjusted such that an error between the output data and the training target values becomes as small as possible. The error between the output data and the training target values is determined, for example, via the distance between the output data and the training target values, and a corresponding metric for output data is determined. In this case, it should be noted that an overfitting is avoided, which is, for example, achieved by means of considering the error between output data generated from test input data and the associated test target values. The test target values are assigned to the test input data, and the test input data and test target values are not used for adjusting the parameters of the machine learning system.

Furthermore, the training data are used to adjust parameters of the machine learning system such that the machine learning system generates reconstruction data. The reconstruction data represent a measure of the familiarity of training data. In the event that training data are known for input data which are to be processed with the trained learning system, the uncertainty in the output data from the machine learning system is low. If, however, little or no training data are known for input data which are to be processed with the trained learning system, then the uncertainty in the output data from the machine learning system is high. That is to say that the uncertainty in the output data from the machine learning system can be quantified via the reconstruction data. The computational expense is moderate, wherein the additional computational expense for calculating the reconstruction data at most roughly corresponds to the computational expense for calculating the output data. Furthermore, the reconstruction data are computed on the basis of the already existing training data, that is to say that no further inputs are necessary here.

The reconstruction data can be generated as a further output of the machine learning system which generates the output data. Alternatively, the machine learning system can include two subsystems, wherein the first subsystem generates the output data and the second subsystem generates the reconstruction data. In the event that the output data and the reconstruction data are generated by two subsystems of the machine learning system, it is important that the training of both subsystems is based on the same training data since only then will the reconstruction data represent the measure of the familiarity of the same training data which have been used for the generation of the output data.

In some embodiments, the reconstruction data are similar to the training input data. This means that the parameters of the machine learning system are adjusted such that an error between the reconstruction data and the training input data becomes as small as possible. In other words, the input data are reconstructed via the reconstruction data.

In some embodiments, the reconstruction data are similar to the training target values, and a deviation of the reconstruction data from the training target values is less than a deviation of the output data from the training target values. This means that the parameters of the machine learning system are adjusted such that an error between the reconstruction data and the training target values is smaller than an error between the output data and the training target values. Since the parameters of the machine learning system have already been adjusted such that an error between the output data and the training target values is as small as possible while avoiding an overfitting, this means that the machine learning system is overfitted for the generation of the reconstruction data.

In some embodiments, the training input data are used as an input to generate the reconstruction data. This is possible both in the event that the reconstruction data are generated as a further output of the machine learning system which generates the output data and in the event that the reconstruction data are generated by a second subsystem of the machine learning system. Alternatively or additionally, the output data can be used as an input to generate the reconstruction data. Since the output data is first available for this, this is only possible in the event that the reconstruction data are generated by a second subsystem of the machine learning system. That is to say that the output of the first subsystem of the machine learning system is then used as an input for the second subsystem of the machine learning system.

In some embodiments, the machine learning system is a neural network. Neural networks are particularly well suited to the method described since they can be easily adjusted. The neural network is in particular a convolutional neural network. The non-linearity of the convolutional neural network does not pose a problem for the usability of the method described.

However, the described method can also be used with other machine learning systems, for example with decision tree learning, with support vector machines, regression analysis or Bayesian networks. Furthermore, it is possible to use the described method in a multi-task classification system. The multi-task classification system comprises, for example, an encoder and a plurality of decoders. Reconstruction data are generated for each decoder and the parameters of the machine learning system are adjusted accordingly. It is additionally possible to divide the machine learning system into multiple slave systems. Each of the slave systems has the functionality of the machine learning system described here. However, the slave systems differ from each other, for example in terms of the type of machine learning system or in terms of the selection of the training data. Output data generated by means of the slave systems can then be combined in order to obtain an improved output.

In some embodiments, the input data include sensor data, in particular image data, radar data and/or lidar data. In the exemplary case of image data, if the reconstruction data are similar to the training input data, the reconstruction data represent a reconstruction of the original image. The more precisely the original image can be reconstructed again, the better known are the training data for this image and the lower the uncertainty in the output data.

The input data can be sensor data of a vehicle. The output data are then, for example, classifications of the objects detected by means of the sensor data. The described method can be used to quantify the uncertainties in the output data for autonomous driving systems.

A further aspect of the invention relates to a method for quantifying uncertainties in output data from a machine learning system which has been trained in accordance with a method for training a machine learning system according to the preceding description.

That is to say that a machine learning system can be, for example, a decision tree learning system, a support vector machine, a learning system based on a regression analysis, a Bayesian network, a neural network or a convolutional neural network. Furthermore, the machine learning system can be a multi-task classification system. The machine learning system can additionally include two subsystems.

The machine learning system generates output data from input data. The input data can be, for example, sensor data, in particular image data, radar data and/or lidar data and can, by way of example, be detected by a vehicle. The output data can be classifications of the input data, that is to say, in particular classifications of the objects detected by the sensor data.

Furthermore, the machine learning system generates reconstruction data. A metric is then used to generate a deviation value from the reconstruction data and the data corresponding to the reconstruction data. This deviation value is a measure of the familiarity of training data for the input data. The deviation value therefore quantifies the uncertainty in the output data and is assigned to the output data.

That is to say that the quantification of the uncertainty is attained by applying the trained machine learning system, wherein the computational expense for this at most roughly corresponds to the computational expense for calculating the output data.

The metric to be used for this depends on which data are the reconstruction data and which are the data corresponding to the reconstruction data. Examples of such metrics are distance metrics or measures of similarity, for example the mean square error, mean absolute error, structural similarity index, or binary cross entropy.

The quality of the uncertainty estimations can additionally be determined. Known methods for this can be found, for example, in “Simple and Scalable Predictive Uncertainty Estimation using Deep Ensembles” by B. Lakshminarayanan, A. Pritzel and C. Blundell (arXiv: 1612.01474, 2017) or in “On Calibration of Modern Neural Networks” by C. Guo, G. Pleiss, Y. Sun and K. Weinberger (arXiv: 1706.04599, 2017).

In some embodiments, the data corresponding to the reconstruction data are the input data. The machine learning system has been trained such that the reconstruction data obtained during the training are similar to the training input data. That is to say that the metric is used to generate the deviation value from the reconstruction data and the input data. If there were training input data which were similar to the input data, the reconstruction data will also be similar to the input data and, therefore, the deviation value will be small. Since, in this case, there were input data which were similar to the training input data, reconstruction data with a low error are also to be expected, so that the small deviation value can be indicative of good output data and, therefore, low uncertainty in the output data. If, on the other hand, there were no training input data which were similar to the input data, then there will be a larger deviation between the reconstruction data and the input data so that the deviation value is large. This corresponds to the larger uncertainty which arises precisely because none of the training input data correspond to the input data.

In some embodiments, the data corresponding to the reconstruction data are the output data generated from the input data. The machine learning system has been trained such that the reconstruction data obtained during the training are similar to the training target values, wherein the deviation of the reconstruction data from the training target values was less than the deviation of the output data generated from the training input data from the training target values. Now, if the deviation of the reconstruction data from the output data established by means of the metric is small, this indicates that there were training input data which were similar to the input data and, consequently, the uncertainty in the output data is also small. If, on the other hand, the deviation of the reconstruction data from the output data established by means of the metric is large, this indicates that there were no training input data which were similar to the input data, which denotes a correspondingly large uncertainty in the output data.

In the event that the deviation of the reconstruction data from the output data established by means of the metric is small, the reconstruction data can be used to improve the output of the machine learning system. To this end, instead of the output data, the reconstruction data, which can represent an even more precise result than the output data due to the training of the machine learning system, can, be output, for example. Alternatively, instead of the output data, an average value of the output data and reconstruction data, which can likewise represent an even more precise result than the output data, can be output, for example.

In some embodiments, the input data are used to generate the reconstruction data. Alternatively or additionally, the output data generated from the input data are used to generate the reconstruction data. Which data are used to generate the reconstruction data depends on which data were used to generate the reconstruction data during the training of the machine learning system.

In some embodiments, the metric is only applied to a part of the reconstruction data and the data corresponding to the reconstruction data. Thus, the metric can, for example, only be applied to a part of an image which is, by way of example, delimited by a bounding box and in particular contains a recognized object. The uncertainty is then quantified separately in the classification of this object. As a further example, the metric can also be applied to the entire image at a lower resolution if, for example, small details are to be considered to be rather unimportant.

In some embodiments, an uncertainty warning is output for output data, the uncertainty of which exceeds a predetermined value. This uncertainty warning can be taken account of accordingly by the system using the output data. For example, during autonomous driving, for which objects recognized by means of the machine learning system on the basis of sensor data are of crucial importance, corresponding safety measures can be initiated, by way of example reducing the speed or handing over control of the vehicle to a driver, in the event of an increased uncertainty in the output data from the machine learning system.

In some embodiments, the input data are stored for further training of the machine learning system for output data, the uncertainty of which exceeds a predetermined value. Corresponding target values are then generated for the input data stored in this way, for example by a classification by a user. These new pairs of input data and target values are then used during training of the machine learning system, so that the machine learning system can then also generate reliable output data from input data which are similar to the new input data.

A further aspect of the invention relates to a system for quantifying uncertainties in output data from a machine learning system. This system comprises an input unit, a computing unit and an output unit. The input unit is configured to receive input data, for example as an interface with sensors. The computer unit is configured to execute the method for quantifying uncertainties in output data from a machine learning system according to the preceding description. The machine learning system has already been trained by means of the method for training a machine learning system according to the previous description. That is to say that the computer unit generates output data from the input data and generates reconstruction data. In addition, the computer unit generates the deviation value which quantifies the uncertainty in the output data from the reconstruction data and the data corresponding to the reconstruction data. The output unit is configured to output the output data generated by the computer unit as well as the uncertainty in the output data and/or the uncertainty warning based on this uncertainty. The output unit is, for example, an interface with a system which further processes the output data.

A further aspect of the invention relates to a vehicle which comprises a system for quantifying uncertainties in output data according to the preceding description. If increased uncertainties are recognized in output data generated by the machine learning system, corresponding measures, in the case of autonomous driving, for example a reduction in speed or handing over control of the vehicle to the driver, can significantly increase safety.

In order to further illustrate the invention, it is described with reference to embodiments represented in the figures. These embodiments are only to be understood to be an example and not to restrict the invention.

### BRIEF DESCRIPTION OF THE DRAWINGS

FIG. 1a shows a flow chart of an exemplary embodiment of a method for training a machine learning system;

FIG. 1b shows a flow chart of a method for quantifying uncertainties in output data, which is suitable for the exemplary embodiment of FIG. 1a;

FIG. 2a shows a flow chart of a further exemplary embodiment of a method for training a machine learning system;

FIG. 2b shows a flow chart of a method for quantifying uncertainties in output data, which is suitable for the exemplary embodiment of FIG. 2a;

FIG. 3a shows a flow chart of yet another exemplary embodiment of a method for training a machine learning system;

FIG. 3b shows a flow chart of a method for quantifying uncertainties in output data, which is suitable for the exemplary embodiment of FIG. 3a;

FIG. 4a shows a flow chart of yet another exemplary embodiment of a method for training a machine learning system;

FIG. 4b shows a flow chart of a method for quantifying uncertainties of output data, which is suitable for the exemplary embodiment of FIG. 4a;

FIG. 5a shows a flow chart of yet another exemplary embodiment of a method for training a machine learning system;

FIG. 5b shows a flow chart of a method for quantifying uncertainties of output data, which is suitable for the exemplary embodiment of FIG. 5a; and

FIG. 6 shows a schematic representation of an exemplary embodiment of a vehicle having a system for quantifying uncertainties of output data.

### DETAILED DESCRIPTION

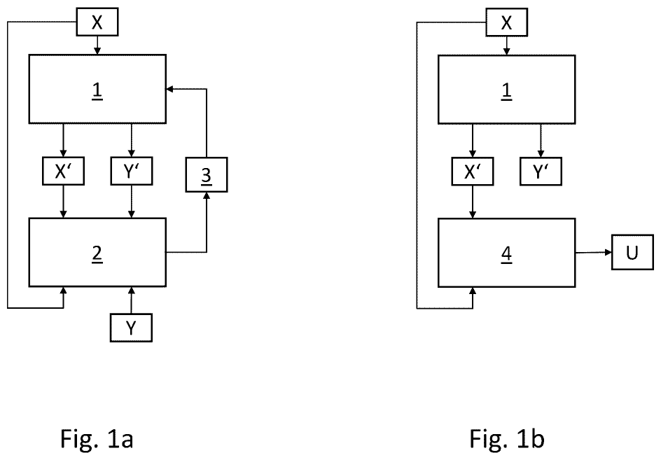

FIG. 1a shows a flow chart of an exemplary embodiment of a method for training a machine learning system 1 and FIG. 1b shows a flow chart of a method for quantifying uncertainties U in output data Y′, which is suitable for the exemplary embodiment of FIG. 1a.

In order to train the machine learning system 1 which is, for example, a decision tree learning system, a support vector machine, a regression analysis-based learning system, a Bayesian network, a neural network or a convolutional neural network, training input data X and training target values Y are provided. The machine learning system 1 is used to generate output data Y′ as well as reconstruction data X′ similar to the training input data X, from the training input data X. The aim of the training is that the output data Y′ are as similar as possible to the training target values Y without performing an overfitting, and that the reconstruction data X′ are as similar as possible to the training input data X. For this purpose, the remaining deviations between the output data Y′ and the training target values Y as well as between the reconstruction data X′ and the training input data X are established from the generated output data Y′ as well as reconstruction data X′ and the training target values Y as well as the training input data X by means of an error function. These deviations are used via a backpropagation 3 to adjust parameters of the machine learning system 1. This is repeated until such time as a predefined correspondence has been attained or until there are signs of an overfitting.

Output data Y′ and reconstruction data X′ are then generated from input data X by means of the machine learning system 1 trained in this way, as depicted in FIG. 1b. The deviation of the reconstruction data X′ from the input data X is then determined by means of a metric 4. The deviation value determined in this way quantifies the uncertainty U in the output data Y′.

As an example, the input data X can be image data of an image and the output data Y′ can be classification data which correspond to objects depicted on the image. If it is now possible to use the machine learning system 1 to generate a reconstructed image X′ which is similar to the original image X, then this indicates that similar input data X were already present during the training of the machine learning system 1 so that the uncertainty U in the output data Y′ is low. If, however, the reconstructed image X′ differs greatly from the original image X, then this indicates that no similar input data X have been used to train the machine learning system 1 and, accordingly, the uncertainty U in the output data Y′ is large.

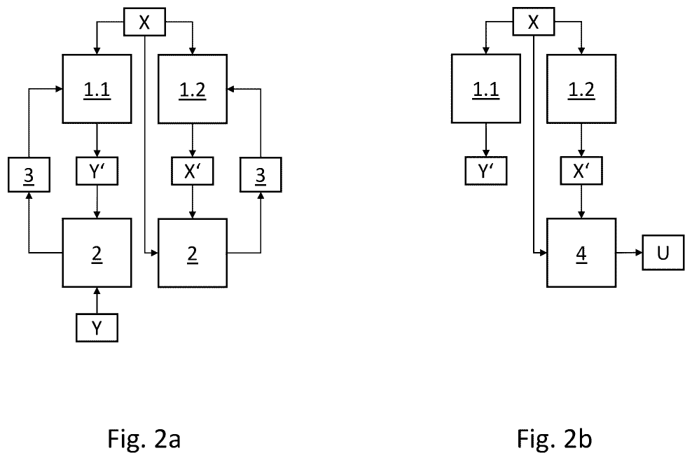

The methods shown in FIGS. 2a and 2b for training a machine learning system 1 or for quantifying uncertainties U in output data Y′ differ from the methods shown in FIGS. 1a and 1b in that the generation of the output data Y′ and the reconstruction data X′ are not generated by a common machine learning system 1, but by a first subsystem 1.1 or a second subsystem 1.2 of the machine learning system 1. It follows from this that the training of the second subsystem 1.2 can also take place, for example, following the training of the first subsystem 1.1, wherein it must be noted that the same training input data X have to be used. Otherwise, the methods correspond to those from FIGS. 1a and 1b. Of course, the error functions 2 and the backpropagation 3 are adjusted to the respective subsystem 1.1 or 1.2 of the machine learning system 1.

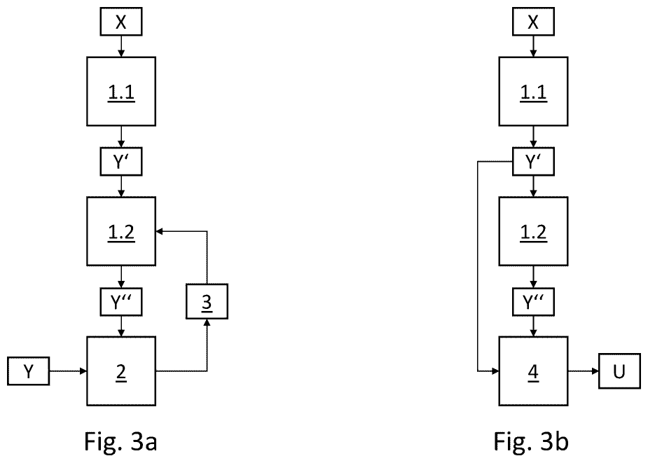

In the case of the method shown in FIGS. 3a and 3b for training a machine learning system 1 or for quantifying uncertainties U in output data Y′, the machine learning system 1 has, in turn, two subsystems 1.1 and 1.2. The subsystem 1.1 generates output data Y′ from the input data X and is trained before the subsystem 1.2. The training of the subsystem 1.1 is not depicted here for reasons of clarity. The subsystem 1.2 receives the output data Y′ generated by the subsystem 1.1 as an input and generates, herefrom, reconstruction data Y″ which are similar to the training target values Y. To train the subsystem 1.2, the generated reconstruction data Y″ are compared with the training target values Y and the parameters of the subsystem 1.2 are adjusted via the backpropagation 3 such that the reconstruction data Y″ are as similar as possible to the training target values Y.

For the quantification of the uncertainty U in the output data Y′, the deviation of the output data Y′ from the reconstruction data Y″ is then determined by means of the metric 4. A strong similarity between the output data Y′ and the reconstruction data Y″ indicates that there were training input data X which are similar to the input data X, so that the uncertainty U in the output data Y′ is assumed to be small. On the other hand, a large difference between the output data Y′ and the reconstruction data Y″ indicates that there were no training input data X which are similar to the input data X, so that the uncertainty U in the output data Y′ is quantified as large.

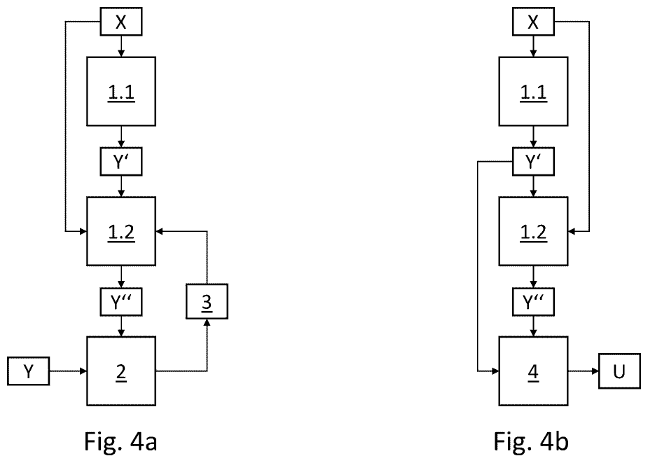

The methods shown in FIGS. 4a and 4b for training a machine learning system 1 or for quantifying uncertainties U in output data Y′ differ from the methods shown in FIGS. 3a and 3b in that the second subsystem 1.2, in addition to the output data Y′ of the first subsystem 1.1, also uses the training input data X or input data X as an input. As a result, the determination of the uncertainty U of the output data Y′ is further improved.

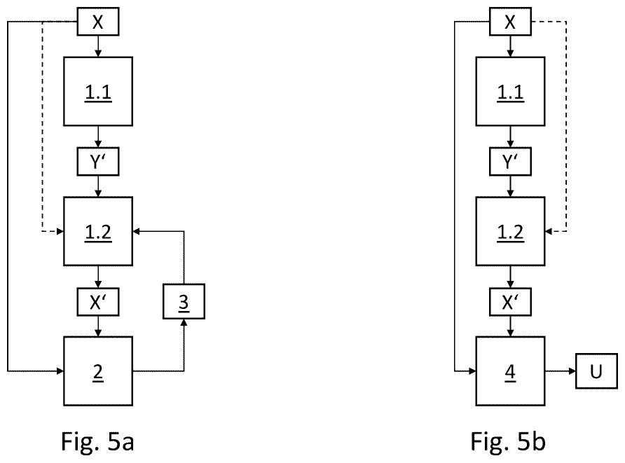

Finally, the methods shown in FIGS. 5a and 5b for training a machine learning system 1 or for quantifying uncertainties U in output data Y′ differ from the methods shown in FIGS. 3a and 3b or FIGS. 4a and 4b in that the second subsystem 1.2 generates the reconstruction data X′ corresponding to the input data X and not the reconstruction data Y″ corresponding to the output data Y′. The use of the training input data X or input data X as an input for the second subsystem 1.2 is optional and therefore indicated by dashed lines.

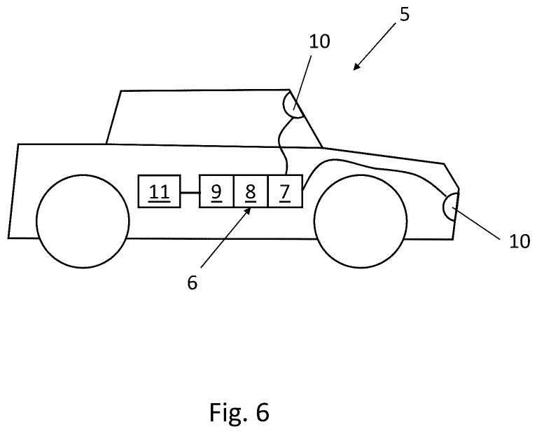

FIG. 6 shows an exemplary embodiment of a vehicle 5 having a system 6 for quantifying uncertainties U in output data Y′. The system 6 includes an input unit 7, a computer unit 8 and an output unit 9. The input unit 7 receives input data X from sensors 10 of the vehicle 5, for example from image sensors, radar sensors or lidar sensors. The received input data X are then forwarded to the computer unit 8 which executes a method for quantifying uncertainties U in output data Y′. The output data Y′ and uncertainties U generated in this way are then forwarded via the output unit 9 to further systems 11 of the vehicle 5, for example to systems 11 for autonomous driving. An uncertainty warning, which is then output if the uncertainty U exceeds a predetermined value, can also be forwarded, together with the output data Y′.

If the uncertainty U is too large or if an uncertainty warning has been output, the system 11 for autonomous driving can then, for example, reduce the speed of the vehicle 5 or hand over control of the vehicle to a driver.

1. A method for training a machine learning system to quantify uncertainties in output data, wherein training data which comprise training input data and training target values are provided, and the training data are used to adjust parameters of the machine learning system such that the machine learning system,
when the training input data are input, generates output data corresponding to the training target values; and
generates reconstruction data which represent a measure of a familiarity of the training data.

2. The method according to claim 1, wherein the reconstruction data correspond to the training input data.

3. The method according to claim 1, wherein the reconstruction data correspond to the training input data, and a deviation of the reconstruction data from the training target values is less than a deviation of the output data from the training target values.

4. The method according to claim 1, wherein at least one of the training input data or the output data are used as an input to generate the reconstruction data.

5. The method according to claim 1, wherein the machine learning system is a neural network.

6. The method according to claim 1, wherein the input data comprise sensor data.

7. A method for quantifying uncertainties in output data from a machine learning system which has been trained in accordance with the method for training the machine learning system according to claim 1, wherein
the machine learning system generates the output data from the input data;
the machine learning system generates the reconstruction data; and
a metric, the reconstruction data and data corresponding to the reconstruction data are used to generate a deviation value, wherein the deviation value is a measure of familiarity of the training data for the input data, quantifies the uncertainty in the output data and is assigned to the output data.

8. The method according to claim 7, wherein the data corresponding to the reconstruction data are the input data.

9. The method according to claim 7, wherein the data corresponding to the reconstruction data are the output data generated from the input data.

10. The method according to claim 7, wherein at least one of the input data or the output data generated from the input data are used to generate the reconstruction data.

11. The method according to claim 7, wherein the metric is only applied to a part of the reconstruction data and the data corresponding to the reconstruction data.

12. The method according to claim 7, wherein an uncertainty warning is output for the output data, the uncertainty of which exceeds a predetermined value.

13. The method according to claims 7, wherein the input data are stored for further training of the machine learning system for the output data, the uncertainty of which exceeds a predetermined value.

14. A system for quantifying uncertainties in output data from a machine learning system, comprising
an input interface having one or more inputs receiving input data;
a computer having one or more inputs coupled to one or more outputs of the input interface, the computer being configured to execute the method according to claim 7; and
an output unit interface having one or more inputs coupled to one or more outputs of the computer and one or more outputs which outputs the output data generated by the computer as well as the uncertainty in at least one of the output data or an uncertainty warning.

15. A vehicle, comprising a system for quantifying uncertainties in output data according to claim 14.

16. The method according to claim 5, wherein the neural network comprises a convolutional neural network.

17. The method according to claim 6, wherein the sensor data comprises at least one of image data, radar data or lidar data.

18. The method according to claim 6, wherein the sensor data comprises data from one or more vehicle sensors.
